(19) United States
(12) Patent Application Publication
(10) Pub. No.: US 2018/0304680 A1
(43) Pub. Date: Oct. 25, 2018

(54) WHEEL BEARING UNIT

(71) Applicant: Schaeffler Technologies AG & Co. KG, Herzogenaurach (DE)

(72) Inventors: Matthias Stahl, Schweinfurt (DE); Natalie Treubert, Röthlein (DE); Frank Eichelmann, Donnersdorf (DE)

(73) Assignee: Schaeffler Technologies AG & Co. KG, Herzogenaurach (DE)

(21) Appl. No.: 15/767,168

(22) PCT Filed: Sep. 2, 2016
(86) PCT No.: PCT/DE2016/200411

§ 371 Date: Apr. 10, 2018

(30) Foreign Application Priority Data
Nov. 2, 2015 (DE) 102015014059.0
Jan. 21, 2016 (DE) 102016200773.4

(51) Int. Cl. B60B 27/00; F16C 19/52; F16C 33/78; F16C 39/02

(52) U.S. Cl. CPC B60B 27/0073; F16C 19/522; F16C 19/186; F16C 39/02; F16C 33/7876

(57) ABSTRACT

Wheel bearing units are disclosed. In one example, a wheel bearing unit includes an outer ring element and an inner ring element, between which there are arranged at least two rolling body rows. The inner ring element may have a radial flange which is fastenable to an axle body or to a wheel. A seal may be provided at a radial flange side between the outer ring element and the inner ring element, wherein the seal has a carrier element. A face surface, which faces toward the radial flange, of the outer ring element may include at least one projection.

### CROSS-REFERENCE TO RELATED APPLICATIONS

This application is the U.S. National Phase of PCT Appln. No. PCT/DE2016/200411 filed Sep. 2, 2016, which claims priority to DE 102015014059.0 filed Nov. 2, 2015 and to DE 102016200773.4 filed Jan. 21, 2016, the entire disclosures of which are incorporated by reference herein.

### TECHNICAL FIELD

The disclosure relates to a wheel bearing unit, such as for motor vehicles.

### BACKGROUND

Wheel bearings are composed of an outer ring and of a wheel bearing hub and of rolling bodies arranged in between. The wheel bearing hub has a radially outwardly directed wheel flange to which, for example, a wheel can be fastened. In certain driving situations, for example when driving over a pothole or against a curbstone, axial and/or radial shocks act on the wheel flange and/or on the wheel bearing hub. Said shocks have the effect that the wheel flange/wheel bearing hub moves in the direction of, and strikes, an outer ring of the wheel bearing unit. The forces that arise in the process are then introduced into the rolling bearing.

EP 2 184 181 B1 has disclosed a wheel bearing unit which has a wheel hub with a wheel flange. A rolling bearing is arranged between an outer ring and the wheel hub. In the described wheel bearing unit, damage to the rolling bearing owing to a lateral shock is avoided by a certain gap width.

### SUMMARY

The disclosure is based on the object of providing a wheel bearing unit which reduces the damage to the rolling bearing in the event of a shock acting on the wheel bearing unit and which furthermore ensures reliable sealing of the bearing.

According to the disclosure, said object is achieved by having an outer ring element and having an inner ring element, between which there are arranged at least two rolling body rows, wherein the inner ring element has a radial flange which is fastenable to an axle body or to a wheel, and a seal is provided at the radial flange side between the outer ring element and the inner ring element, wherein the seal has a carrier element, wherein a face surface, which faces toward the radial flange, of the outer ring element has at least one projection.

The disclosure is based on the realization that, in certain driving situations, for example when driving over a pothole or against a curbstone, axial and/or radial shocks act on the wheel bearing unit. Said shocks have the effect that the inner ring element and/or the radial flange make contact with the outer ring element. In the wheel bearing unit according to the disclosure, a face surface, which faces toward the radial flange, of the outer ring element has at least one projection. Said projection is designed such that, in the event of an axial or radial shock of the inner ring element and/or radial flange, said projection absorbs the force that acts as a result, and dissipates said force in order to prevent damage to the rolling bearing and/or to the raceways. By contrast to the prior art, such a construction may entail higher manufacturing costs, but said construction leads overall to an increase of the service life of the wheel bearing unit.

The face surface of the outer ring element may have one or more projections which are arranged so as to be distributed over the circumference. If the outer ring element likewise has a radial flange with bores, the projection or the multiple projections may be arranged so as to be oriented correspondingly to the bores. Furthermore, the disclosure may relate to a wheel bearing unit with a row or multiple rows of rolling bodies in an X or O arrangement. Here, the rolling bodies may be formed with equal or different diameters and/or of a different rolling bearing type.

The at least one projection on the face surface is preferably formed as a ring segment. This means that the at least one projection extends in the circumferential direction not over the entire ring surface of the face surface, but rather extends in the circumferential direction only over a partial section of the face surface. If multiple projections are provided, these are provided on the face surface so as to be distributed in the circumferential direction. This has the advantage that the one or more projections may be provided in a manner dependent on the embodiment of the wheel bearing unit, the available structural space and the requirements.

According to one refinement of the disclosure, a section of the carrier element of the seal forms the projection. Here, the carrier element is designed and positioned such that it extends as at least one projection along, or as a segment on, the face surface of the outer ring element. The carrier element may preferably be formed as a metal sheet, though may also be formed from some other metallic or non-metallic material. Such an embodiment has the advantage that the carrier metal sheet of the seal itself forms a pre-seal, which is provided in the manner of a labyrinth seal. This has the effect that the ingress of contaminants, such as for example rainwater or dust, from the outside into the bearing or to the further seal can be reduced or prevented. This construction leads overall to improved sealing performance and thus to an increase of the service life of the wheel bearing unit.

The section of the carrier element is preferably of bracket-like form. “Section of the carrier element” is to be understood to mean that section which forms the at least one projection; said section is also regarded as first section. A bracket-like form may for example be understood to mean an L shape as viewed in cross section. The carrier element may advantageously have a second section which extends in ring-shaped fashion over an entire inner circumference of the outer ring element and which is attached to said inner circumference, wherein the first section, adjoining the second section, extends in the form of a bracket radially along the face surface in segmented fashion. The disclosure is not only restricted to one bracket; it is also possible for multiple brackets to be provided.

The carrier element is preferably connected in non-positively locking, positively locking or cohesive fashion to the outer ring element. It is thereby ensured that the carrier element and thus the at least one projection remain in a fixed position throughout the service life. The type of connection is dependent on the embodiment of the carrier element, that is to say for example material, shape etc.

In one refinement of the disclosure, the carrier element may have at least one sealing lip. For this purpose, a further section which indirectly or directly adjoins the second section of the carrier metal sheet may have at least one sealing lip. The at least one sealing lip is preferably produced from an elastomer material and is vulcanized onto the carrier metal sheet. Here, the at least one sealing lip bears directly or indirectly with contact against the inner ring element or the radial flange thereof. For improved sealing performance, multiple sealing lips are provided, which may be formed axially and also radially.

In an alternative refinement of the disclosure, the at least one projection has a coating. The coating may serve for reducing generated noises.

### BRIEF DESCRIPTION OF THE DRAWINGS

Example embodiments of the disclosure will be presented below on the basis of three figures. In the figures:

FIG. 1 shows a partial longitudinal section through a wheel bearing unit according to the disclosure,

FIG. 2 is an illustration of an outer ring element of the wheel bearing unit shown in FIG. 1, as per a first embodiment, and

FIG. 3 is an illustration of an outer ring element of the wheel bearing unit shown in FIG. 1, as per a second embodiment.

### DETAILED DESCRIPTION

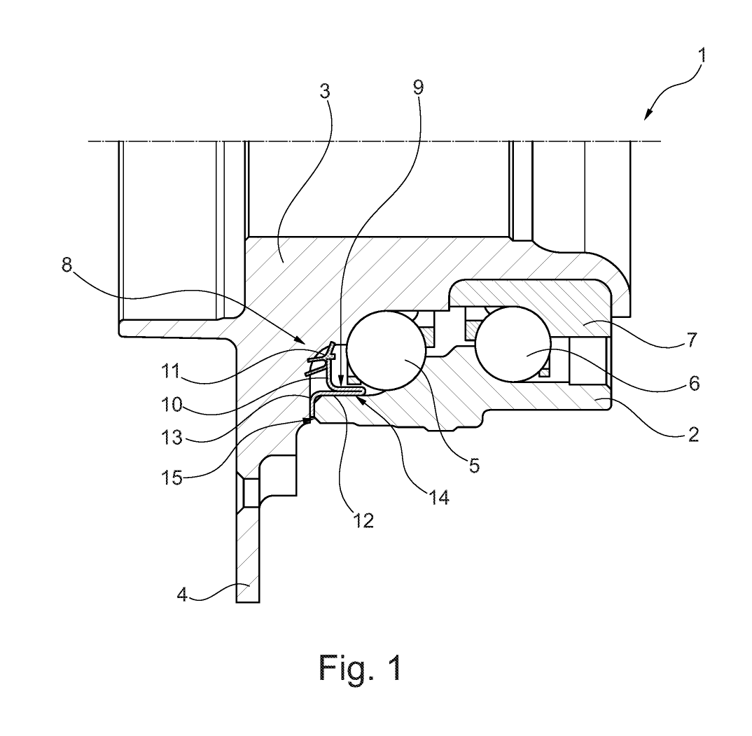

FIG. 1 shows a wheel bearing unit 1 according to one embodiment, which wheel bearing unit is assigned to a vehicle wheel (not illustrated). The wheel bearing unit 1 comprises an outer ring element 2 and an inner ring element 3. The inner ring element has a radial flange 4, which is fastenable to a wheel or axle body (not illustrated in any more detail). Furthermore, the wheel bearing arrangement has two axially spaced-apart rolling body rows 5, 6, the rolling bodies of which are guided at the outside in the outer ring element 2. At the inside, the rolling bodies of the rolling body row 5 are guided directly in a raceway of the inner ring element 3, and the rolling bodies of the rolling body row 6 are guided in an inner ring 7 fixed to the inner ring element 3.

A seal 8 is provided between the outer ring element 2 and the inner ring element 3. The seal 8 has a carrier element 9. As can also be seen, the carrier element 9 has a section 10 on which three sealing lips 11 are provided in this exemplary embodiment. Here, said sealing lips 11 bear against the inner ring element 3 or against the radial flange 4 thereof. Adjoining the section 10, a second section 12 extends over a curved region, and said second section is adjoined by a first section 13 of the carrier element. The second section 12 is connected in positively locking, non-positively locking or cohesive fashion to the outer ring element 2, that is to say at the inner circumference 14.

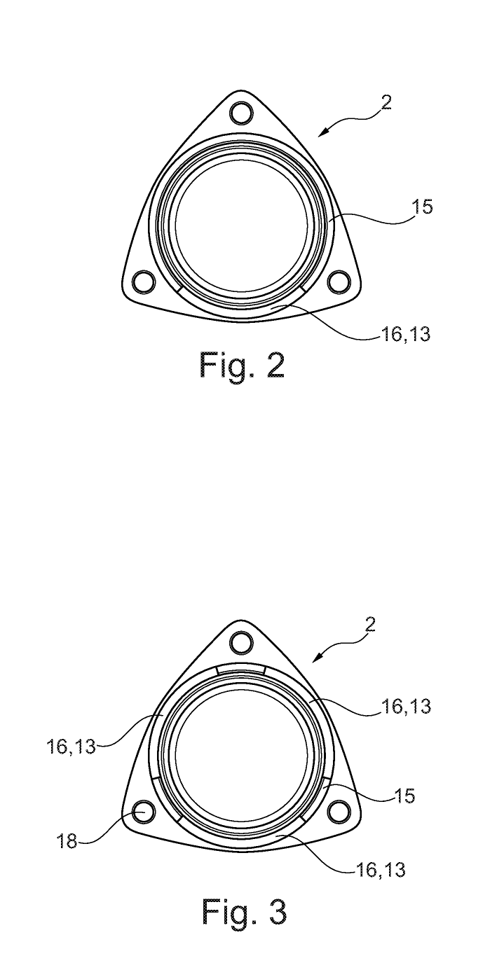

For the more detailed explanation of a first embodiment, reference is additionally made below to FIG. 2. A face surface 15, which faces toward the radial flange 4, of the outer ring element 2 has at least one projection 16. As can be seen in FIG. 2, the face surface 15 has a projection 16 which is formed as a ring segment. Here, the projection 15 is formed by the first section 13 of the carrier element 9 of the seal 8.

Here, the carrier element 9 is formed from a metallic or non-metallic material. Here, the first section 13 of the carrier element 9 has a bracket-like form, that is to say an L shape in cross section. This means that the first section 13 extends radially outward from the second section 12. Here, the second section 12 of the carrier element 9 extends in ring-shaped fashion along the inner circumference 14 of the outer ring element 2. As can also be seen from FIG. 2, the projection 16 extends in segmented form over the face surface 15, and not over the entire circumference of the face surface 15.

Furthermore, in this exemplary embodiment, a single projection 16 is provided.

In certain driving situations, for example when driving over a pothole or against a curbstone, axial and/or radial shocks may act on the wheel bearing unit. Said shocks have the effect that the inner ring element 3 and/or the radial flange 4 make contact with the outer ring element 2. The projection 16 provided in the wheel bearing unit 1 according to the disclosure is designed such that, in the event of an axial or radial shock of the inner ring element 3 and/or radial flange 4, said projection absorbs the force that acts as a result, and dissipates said force in order to prevent damage to the rolling bearing and/or to the raceways. Here, in the event of an axial or radial shock, contact is made only with the projection 16. The disclosure is however not restricted to a single projection 16.

FIG. 3 shows a further embodiment of the disclosure. To simplify the description, identical parts are denoted by the same reference designations as in the preceding FIGS. 1 and 2. The description is restricted only to the distinguishing features in relation to FIG. 1 and FIG. 2.

FIG. 3 is an illustration of an outer ring element 2 of the wheel bearing unit 1 shown in FIG. 1, as per a second embodiment. In this embodiment, by contrast to FIG. 2, three projections 16 are provided on the face surface 15 so as to be distributed over the circumference of the face surface 15. Said projections 16 are, as already described in FIGS. 1 and 2, formed by first sections 13 of the carrier element 9.

As can be seen from FIG. 3, the outer ring element 2 likewise has a radial flange 17 with bores 18. Here, the projections 16 are arranged so as to be oriented correspondingly between the bores 18.

### LIST OF REFERENCE DESIGNATIONS

1. Wheel bearing unit
2. Outer ring element
3. Inner ring element
4. Radial flange
5. Rolling body row
6. Rolling body row
7. Inner ring
8. Seal
9. Carrier element
10. Section of the carrier element
11. Sealing lip
12. Second section of the carrier element
13. First section of the carrier element
14. Inner circumference
15. Face surface
16. Projection
17. Radial flange
18. Bore

1. A wheel bearing unit, comprising:
an outer ring element and an inner ring element, between which there are arranged at least two rolling body rows, wherein the inner ring element has a radial flange which is fastenable to an axle body or to a wheel,
a seal provided at a radial flange side between the outer ring element and the inner ring element, wherein the seal has a carrier element; and
a face surface, which faces toward the radial flange, of the outer ring element including at least one projection.

2. The wheel bearing unit as claimed in claim 1, wherein the at least one projection on the face surface is formed as a ring segment.

3. The wheel bearing unit as claimed claim 1, wherein a section of the carrier element of the seal forms the projection.

4. The wheel bearing unit as claimed in claim 3, wherein the section of the carrier element is of bracket-like form.

5. The wheel bearing unit as claimed in claim 1, wherein the carrier element is connected in non-positively locking, positively locking, or cohesive fashion to the outer ring element.

6. The wheel bearing unit as claimed in claim 1, wherein the carrier element has at least one sealing lip.

7. The wheel bearing unit as claimed in claim 1, wherein the at least one projection has a coating.
